(19) United States
(12) Patent Application Publication
(10) Pub. No.: US 2009/0230099 A1
(43) Pub. Date: Sep. 17, 2009

(54) Method and Apparatus in Connection with Laser Use

(75) Inventors: Kari Aalto, Lempaala (FI); Veli-Pekka Immonen, Hameenlinna (FI)

Correspondence Address: VENABLE LLP, P.O. BOX 34385, WASHINGTON, DC, 20043-9998, US

(73) Assignee: LASER LANE OY, Hameenlinna (FI)

(21) Appl. No.: 12/085,177

(22) PCT Filed: Jul. 26, 2006
(86) PCT No.: PCT/FI2006/000266

§ 371 Date: May 19, 2008

(30) Foreign Application Priority Data
Nov. 17, 2005 (FI) 20051173

(51) Int. Cl. B23K 26/00

(52) U.S. Cl. 219/121.61

(57) ABSTRACT

A method in connection with laser use, wherein one or more laser beams emitted by one or more laser sources are focused by beam guiding elements on a fusing spot. A filler delivered to the fusing spot is melted, especially for performing a welding, coating, and/or piece manufacturing process. The filler includes a substantially solid-state, elongated filler material that is fed by a delivery system to the fusing spot. The fusing spot is centrally located relative to the one or more laser beams focusing on the fusing spot. The one or more laser beams are diverged with a multi-segment mirror, especially for maintaining the symmetry of the intensity distribution thereof, whereby beams or divisional beams, reflecting from its various segment elements in substantially divergent directions, are converged on the fusing spot by a condenser system included in the beam guiding elements.

The invention relates to a method in connection with laser use, wherein one or more laser beams emitted by one or more laser sources are focused by means of beam guiding elements on a fusing spot, whereat a filler delivered thereto is melted, especially for performing a welding, coating, piece manufacturing and/or the like process. The employed filler comprises a substantially solid-state, elongated filler material, such as a wire or the like, which is fed by means of a delivery system to the fusing spot centrally relative to said one or more laser beams focusing on the fusing spot.

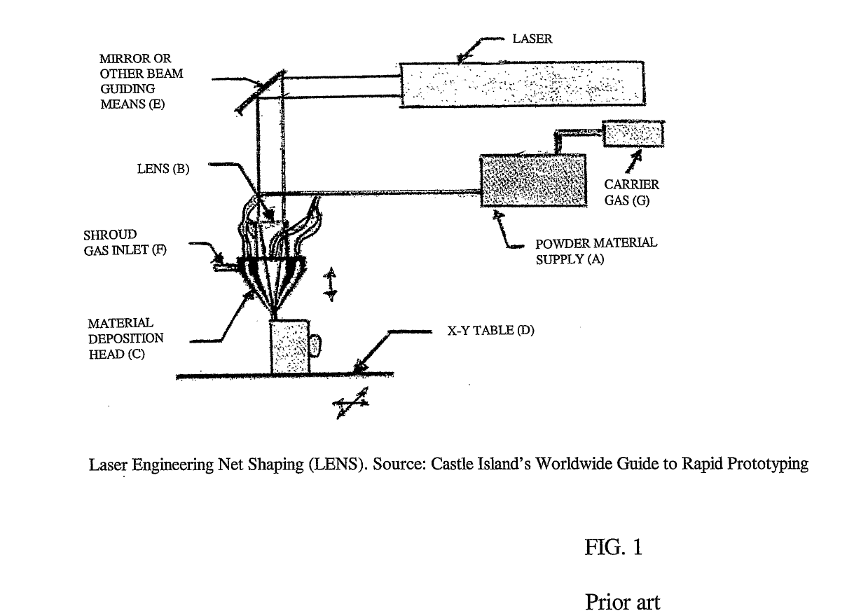

For example LENS (Laser Engineered Net Shaping) rapid manufacturing technique (RP, Rapid Prototyping), as shown for example in FIG. 1, uses a single laser beam, focused in an optically centralized manner on a focal point, for producing a fused spot on a substrate material, whereby a powder to be added thereto is sprayed from opposite sides of the laser beam while being heated with the laser beam. Consequently, the spraying powder melts and bonds with the spot fused in the substrate material. However, the delivery of a filler material in the form of powder is wasteful in terms of energy, the efficiency being typically about 70%, and even that high on the condition that the sprayed powder can be fed in its entirety inside a laser beam. Therefore, the efficiency in a normal case is substantially poorer, since generally as much as most of the powder is blown away to the environment. The efficiency, in turn, has a direct impact on the speed of a laser process and on the price of an article manufactured by the discussed process.

On the other hand, when laser is used e.g. in welding or coating, the feed of a filler supplied in solid state is in current technology generally performed, as e.g. in covered electrode metal arc welding or flux cored arc welding, by continuously feeding filler wire from ahead of the moving burn spot, the practical implementation of which is highly inconvenient, especially with an unsteady processing direction. In practice, what is called for in this context is highly advanced automatics and sophisticated basic equipment in the relative shifting of a burning apparatus and an x-y plane used as the substrate.

It is further prior known from patent publications JP2003311456, EP 1 179 382 and U.S. Pat. No. 6,269,540 to utilize, in association with a laser source, a substantially solid-state filler which is delivered to a fusing spot centrally with respect to one or more laser beams focused thereon.

The first of the above-cited solutions is based on providing the apparatus with laser sources disposed along the circumference in radial direction, the laser beams emitted thereby being focused by optical guide elements on a fusing spot from around a supplied filler. A practical implementation of such solution is difficult as the size of laser sources inherently limits the number of circumferentially disposed laser sources or increases excessively the total diameter of the discussed apparatus. On the other hand, the implementation consistent with the last-cited solution, at least from the viewpoint of a person skilled in the art, is not per se applicable, with technical solutions presented therein, particularly to the use of carbon dioxide laser, which is why the utility of this particular solution is highly restricted in practice.

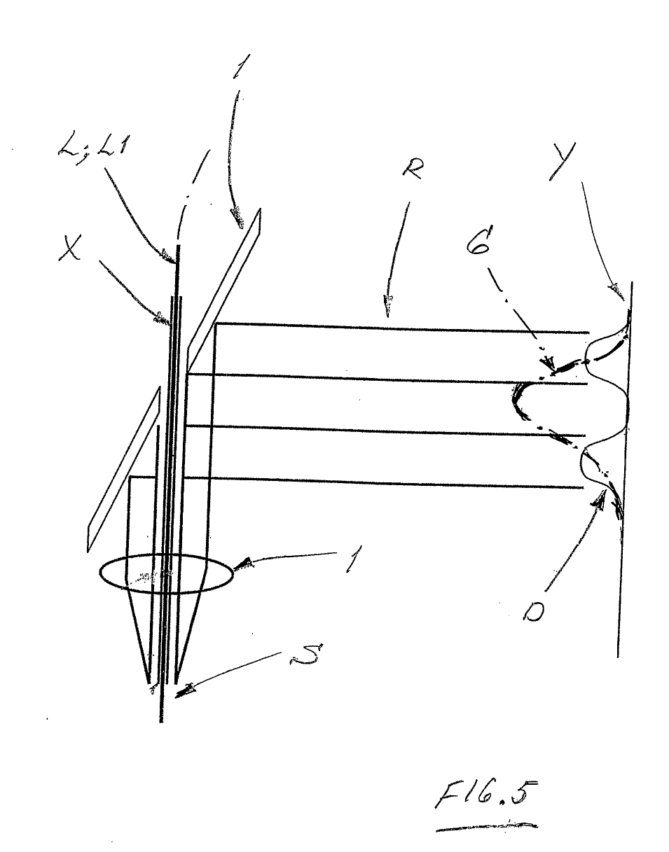

Further, an objective in the solution disclosed in patent publication EP 1 179 382 has been to correct “a shadow problem” occurring in a laser beam whose intensity distribution is consistent with a so-called Gaussian curve, which means in practice that, when implemented with technology shown in principle in FIG. 5, the centrally supplied filler wire causes a shadow in the intensity distribution applied to the fusing spot. Hence, an objective in this particular solution has been to cut the mid-portion of a maximum intensity distribution off the laser beam and to return it to the fusing spot wherever there is a shadow caused by the filler wire.

This type of implementation breaks up the original intensity distribution of a laser beam in such a way that part of a fusing spot receives a per se homogeneous intensity distribution, yet part of it assumes a more powerful intensity distribution as the latter has been cut off the laser beam's maximum intensity range. Thus, the discussed solution is not sufficiently functional in practice, because the final result regarding the quality of processing is then dependent e.g. on a processing direction (homogeneous/inhomogeneous intensity distribution). Hence, the discussed solution has not been successful in providing a decisive improvement in terms of eliminating a “shadow” problem, as it has merely changed the nature of the problem.

A method according to the present invention has an objective to provide a decisive improvement regarding the foregoing drawbacks and thereby to raise substantially the available prior art. In order to accomplish this objective, a method of the invention is principally characterized in that one or more laser beams are diverged with a multi-segment mirror, especially for maintaining the symmetry of the intensity distribution thereof, whereby beams or divisional beams, reflecting from its various segment elements in substantially divergent directions, are converged on a fusing spot by means of a condenser system included in beam guiding elements.

The most important benefits offered by a method of the invention include the simplicity and efficiency of the method itself and the equipment population applicable thereto, enabling a laser processing which is significantly faster and more versatile than what is used at present. In addition, a method of the invention serves to minimize waste of material, as it enables a hundred percent supply of the filler wire to a fusing spot and processing the same with an all-round homogeneous laser beam without a so-called shadow effect, by virtue of which the method also enables processing that is remarkably easier to control and cleaner than currently employed solutions. In addition, by virtue of precisely focused homogeneous fusion, the method produces a surface finish which is remarkably better than what is obtainable by currently available methods. In a method of the invention, it is further possible to promote the melting of a filler wire by simultaneously reducing the power demand of a laser source by preheating the filler material almost to its melting point prior to its delivery to the fusing spot.

Preferred applications for a method of the invention are presented in dependent claims directed thereto.

The invention relates also to an apparatus as defined in the independent claim for applying the method, the features principally characteristic of said apparatus being presented in the characterizing clause of the same claim.

The most important benefits offered by an apparatus of the invention include the simplicity and efficiency of the equipment population applicable thereto, as well as an optimal surface finish obtainable thereby. The efficiency provided by an apparatus of the invention is remarkably higher than what is obtained in currently available solutions, based e.g. on the use of a powdered filler material, since by a continuous feed of solid wire, effected by a totally homogeneous laser beam, it is possible to ensure that the intensity distribution of the original laser beam be focused by a hundred percent on a fusing spot, whereby the processing direction can be completely arbitrary. An apparatus of the invention is also readily variable for a particular application, such as e.g. for welding, coating, piece manufacturing, whereby it is possible to make use of an xy-plane associated with the laser apparatus. On the other hand, the discussed plane and the head of a laser apparatus are still preferably movable relative to each other also in z-direction, which enables the manufacture of e.g. three-dimensional articles by adding vertically successive layers of material to the substrate material. In an apparatus of the invention, it is naturally possible to employ as a filler material not only metal-based ingredients but also but also other materials such as, for example, plastics, resin, glass, etc. In addition, the apparatus makes it possible to assemble an article partially from e.g. an inert material, the removal of which is possible in further processing, e.g. in the production of articles including hollow or negative inclined surfaces, which is very difficult, if not outright possible to achieve e.g. with LENS type of rapid prototyping methods as described before. Furthermore, an apparatus of the invention enables the manufacture of articles, wherein integrally interfused material layers of various natures are utilized by switching a wire delivered during the manufacturing process and/or a nozzle head involved in the process at a given time. The dependent claims directed to an apparatus of the invention set forth preferred embodiments for an apparatus of the invention.

The invention will be explained in detail in the following specification with reference to the accompanying drawings, in which

FIG. 1 depicts a general operating principle for a LENS manufacturing method representing the prior art,

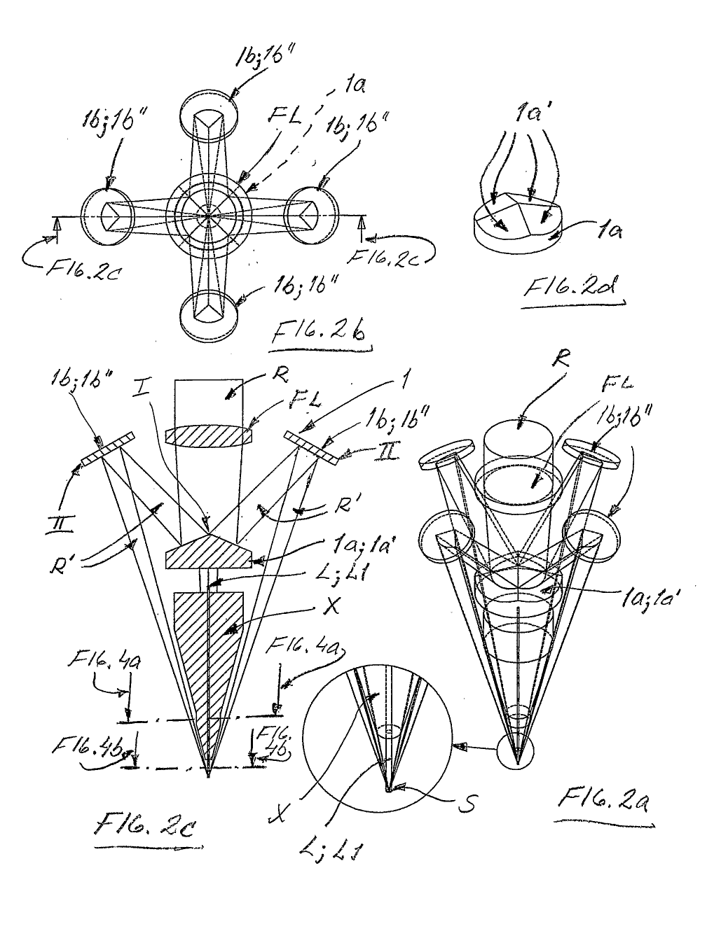

FIGS. 2a-2d show one preferred apparatus, operating according to a method of the invention on symmetrical principle, in a perspective view, an overhead view and a cross-sectional view, and a multi-segment mirror included therein, in a perspective view,

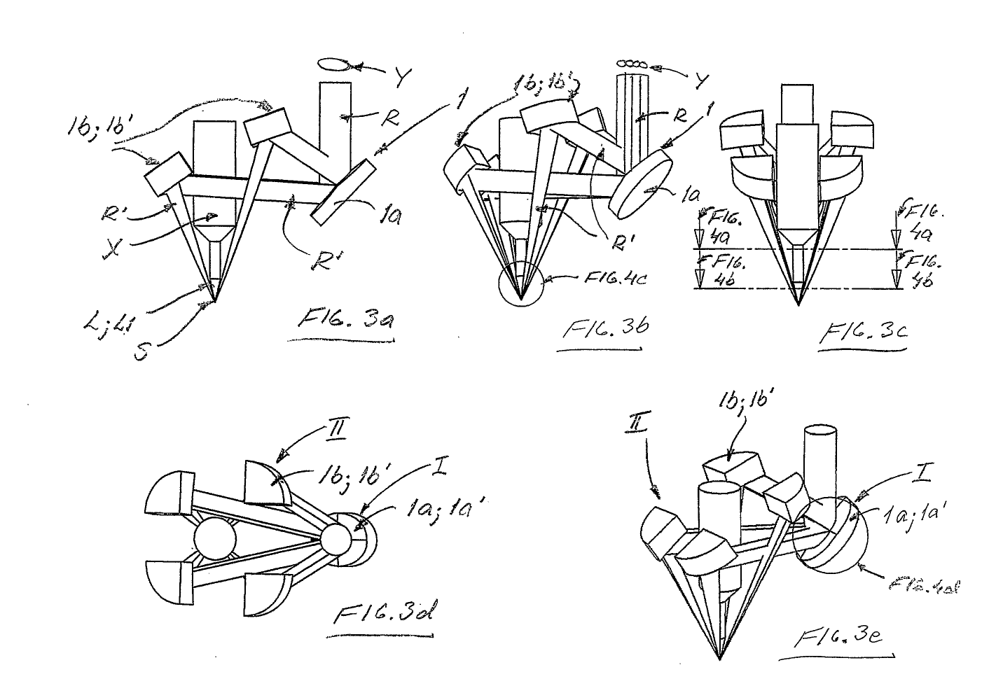

FIGS. 3a-3e show one preferred apparatus, operating according to a method of the invention on asymmetrical principle, in perspective views from various directions,

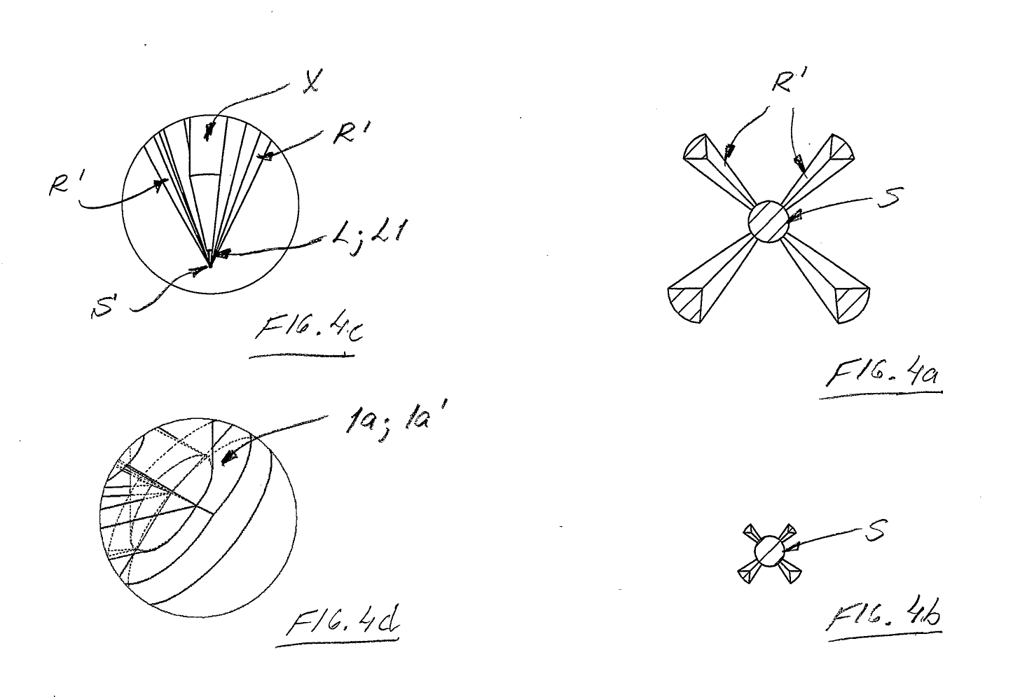

FIGS. 4a-4d show sections and enlargements from FIGS. 2c, 3b, 3c and 3e, and

FIG. 5 depicts a so-called shadow effect problem in a laser use based on central wire delivery.

The invention relates to a method in connection with laser use, wherein one or more laser beams R emitted by one or more laser sources Y are focused by means of beam guiding elements 1 on a fusing spot S, whereat a filler L delivered thereto is melted, especially for performing a welding, coating, piece manufacturing and/or the like process. The employed filler comprises a substantially solid-state, elongated filler material L; L1, such as a wire or the like, which is fed by means of a delivery system X to the fusing spot S centrally relative to a single laser beam R focusing thereon as shown in FIG. 3a or several. laser beams R focusing thereon as shown in FIG. 3b. The one or more laser beams R are diverged I with a multi-segment mirror 1a, especially for maintaining the symmetry of the intensity distribution thereof, whereby beams or divisional beams R′, reflecting from its various segment elements 1a′ in substantially divergent directions, are converged II on the fusing spot S by means of a condenser system 1b included in the beam guiding elements 1.

In a type of solution shown e.g. in FIG. 5, the above-described procedure makes it possible to obviate a shadow cast by the filler wire L; L1 on the fusing spot S, especially when using a laser beam intensity distribution making use of a conventional Gaussian curve G.

In reference to the arrangements shown in FIGS. 2a-2c and 3a-3e, the condenser system 1b in a preferred embodiment comprises a mirror array 1b′, 1b″, a lens array and/or the like, whereby diverged beams or divisional beams R′ are converged, as shown in FIGS. 4a and 4b, with an intensity distribution substantially equal to the one or more original laser beams R on the fusing spot S symmetrically relative to the filler material L; L1 supplied thereto.

In a further preferred embodiment, the one or more laser beams R are diverged I by means of the segment elements 1a′ of a multi-segment mirror, polished for reflections in directions substantially divergent from each other, and converged by means of a focusing lens FL and substantially flat and/or adaptive mirrors 1b, 1b″ included in the condenser system. This type of solution is feasible especially in a so-called symmetrical implementation. In a solution optional to what is described above, it is also possible to execute the method by a so-called asymmetrical arrangement, which does not necessarily comprise a separate focusing lens but, instead, makes use of focusing paraboloidal mirrors 1b; 1b′.

Accordingly, a method of the invention is capable of being applied by means of the symmetrical multi-segment mirrors 1a and the condenser system 1b disposed concentrically relative to the fusing spot S, as shown especially in FIGS. 2a-2c. Thus, it is further possible to set up the condenser system by first of all utilizing substantially flat mirror surfaces 1b″ and one or more focusing lenses FL. In such a solution, it is further possible to make use of so-called adaptive mirrors, having a focal distance whose adjustment is possible through the action of a pressure fluid by convexing/concaving the mirror surface thereof. A symmetric configuration established like this is first of all beneficial in the sense that the size of an apparatus consisting thereof is minimized in radial direction.

In a solution optional to what is described above, it is also possible to utilize an asymmetric condenser system consisting of a multi-segment mirror 1a, eccentric relative to the fusing spot S, and of focusing paraboloidal mirrors 1b′, as shown in FIGS. 3a-3e.

In a further preferred embodiment of the method, the laser source Y is provided by one or more CO2-, NdYAG-, diode-, fiber laser sources Y and/or the like.

In a further preferred embodiment, melting of the filler wire L; L1 at the fusing spot S is assisted by focusing the maximum intensity of the laser beam R on a section between its mid-portion and outer rim and by reducing the laser beam intensity in its mid-portion and outer rim by making use of a so-called donut beam D or the like as shown particularly in FIG. 4. Based on a three-dimensional study of the matter, it should be noted at this point that the above-explained shadow effect cannot be totally eliminated by means of a donut beam alone.

In a preferred embodiment, the filler L; L1 is provided by using an essentially metal-based material, such as 0.1-1.5 gauge metal wire, which, in a further preferred embodiment, is preheated almost to the material's melting point upstream of the fusing spot S. In this context, it is possible to provide a useful filter material by using e.g. steel, aluminum or any appropriate metal or metal alloy.

Accordingly, the beam guiding elements 1 of configurations, shown e.g. in FIGS. 2a-2c. and 3a-3e and making use of the above-described method, include a multi-segment mirror 1a for diverging (I) one (FIG. 3a) or several (FIG. 3b) laser beams R, especially for maintaining the symmetry of the intensity distribution thereof, and a condenser system 1b for converging II beams or divisional beams R′, reflecting from various segment elements 1a′ of the multi-segment mirror in substantially divergent directions, on the fusing spot S.

In a preferred embodiment, the condenser system 1b comprises a mirror array 1b′, 1b″, a lens array and/or the like for converging, as shown especially in FIGS. 4a and 4b, the diverged beams or divisional beams R′, having an intensity distribution substantially equal to the one or more original laser beams R, on the fusing spot S symmetrically relative to the filler material L; L1 supplied thereto.

In preferred embodiments, the segment elements of a multi-segment mirror consist of mirror surfaces 1a; 1a′, polished for reflections in directions substantially divergent from each other, and the condenser system, for example in a symmetric configuration as shown in FIGS. 2a-2c, consists of a focusing lens (FL) and substantially flat and/or adaptive mirrors 1b; 1b″ or, in an asymmetric configuration as shown in FIGS. 3a-3e, of focusing paraboloidal mirrors 1b; 1b′.

In a further preferred embodiment, the laser source Y included in the apparatus comprises one or more CO2-, NdYAG-, diode-, fiber laser sources and/or the like. In addition, the apparatus can be provided with a heating assembly for preheating an essentially metal-based material, such as 0.1-1.5 gauge metal wire or the like, used as the filler L; L1, almost to the materials melting point upstream of the fusing spot S.

For example, the use of a fiber laser enables the use of laser sources of, for example, about 100 watts. Respectively, the wavelength of a laser beam in fiber is, for example, approximately 10,090 nm and the standard thereof is 0.3 nm·mrad.

It is obvious that the invention is not limited to the embodiments described or specified above, but it can be varied according to the original inventive concept within the scope defined in the appended claims. Thus, for example, when it is desirable to protect the flux formed in laser processing from ambient atmosphere, i.e. for example from air, and especially from nitrogen and oxygen present therein, which may have an embrittling effect on a metal solidifying in the wake of melting, it is possible to take advantage of a technique, known as such e.g. in welding technology, by using for example a shroud gas during the course of laser processing. Such shroud gases may include for example argon, helium, and carbon dioxide or combinations of the above. On the other hand, it is also possible to take advantage of an alloyed filler wire, the shroud being provided by slag separating in laser fusion. Another possibility in a method and apparatus of the invention is to make use of a hollow filler wire, through the inside of which a shroud gas and/or shielding agents or other possibly desired alloying elements can be delivered to the melt.

1. A method in connection with laser use, the method comprising:
focusing on a fusing spot with beam guiding elements one or more laser beams emitted by one or more laser sources;
feeding a filler to the fusing spot, the filler being especially for performing a welding, coating, and/or piece manufacturing process, the filler comprising a substantially solid-state, elongated filler material the filler being fed with a delivery system to the fusing spot centrally relative to said one or more laser beams focusing on the fusing spot,
diverging the one or more laser beams with a multi-segment mirror, especially for maintaining the symmetry of the intensity distribution thereof, whereby beams or divisional beams, reflecting from its various segment elements in substantially divergent directions, are converged on the fusing spot with a condenser system included in the beam guiding elements, wherein the filler is provided by using an essentially metal-based material, which is preheated almost to the material's melting point upstream of the fusing spot, and
melting the filler.

2. The method according to claim 1, further comprising:
utilizing shroud gas during the course of laser processing in order to protect flux formed in laser processing from ambient atmosphere.

3. The method according to claim 1, further comprising:
protecting flux formed in laser processing from ambient atmosphere by using alloyed filler wire.

4. The method according to claim 1, further comprising:
utilizing a hollow filler wire to deliver to the melt shroud gas and/or shielding agent or other desired alloying element.

5. The method according to claim 1, wherein melting of the filler wire at the fusing spot is assisted by focusing the maximum intensity of the laser beam on a section between its mid-portion and outer rim and by reducing the laser beam intensity in its mid-portion and outer rim by making use of a so-called donut beam.

6. An apparatus in connection with laser use, which is intended for focusing one or more laser beams emitted by one or more laser sources on a fusing spot for melting a filler delivered thereto, especially for performing a welding, coating, and/or piece manufacturing process, said apparatus comprising:
one or more laser sources;
optically refracting and/or transparent beam guiding elements for focusing said one or more laser beams produced by the laser source/sources on the fusing spot, the beam guiding elements include a multi-segment mirror for diverging said one or more laser beams, especially for maintaining the symmetry of the intensity distribution thereof, and a condenser system for converging beams or divisional beams, reflecting from various segment elements of the multi-segment mirror in substantially divergent directions, on the fusing spot;
a delivery system for feeding a solid-state, elongated filler material to the fusing spot centrally relative to said one or more laser beams focusing on the fusing spot; and
a heating assembly for preheating an essentially metal-based material used as the filler, almost to a melting point of the material upstream of the fusing spot.

7. The apparatus according to claim 6, further comprising:
a source of shroud gas for providing shroud gas during laser processing to protect the flux from ambient atmosphere.

8. The apparatus according to claim 6, further comprising:
a source of alloyed filler wire for providing alloyed filler wire to protect the flux formed in laser processing from ambient atmosphere.

9. The apparatus according to claim 8, further comprising:
a source of hollow filler wire for providing hollow filler wire for laser processing to deliver to the melt through the inside thereof shroud gas and/or shielding agent or other desired alloying elements.
